(19) United States
(12) Patent Application Publication
(10) Pub. No.: US 2007/0135055 A1
(43) Pub. Date: Jun. 14, 2007

(54) Combination quad flat no-lead and thin small outline package

(76) Inventors: Lee Sang Ho, Suwon (KR); Nelson Punzalan, San Pablo City (PH); Chee Key Chung, Kaohsiung (MY)

Correspondence Address: TROP PRUNER & HU, PC, 1616 S. VOSS ROAD, SUITE 750, HOUSTON, TX, 77057-2631, US

(21) Appl. No.: 11/301,713

(22) Filed: Dec. 13, 2005

(51) Int. Cl. H04B 17/00

(52) U.S. Cl. 455/67.11

(57) ABSTRACT

The characteristics of a radio frequency package having short path length and the characteristics of a logic or memory package may be combined so that a high input/output connection is provided together with good radio frequency performance. In some embodiments, a non-radio frequency logic or memory die may be stacked on top of a larger radio frequency die. The radio frequency die may be connected to conventional quad flat no-lead lands. The non-radio frequency or logic or memory die may be connected to conventional leads. In some cases, some contacts on the radio frequency integrated circuit may be connected to leads as well, increasing the input/output capabilities of the radio frequency die.

### BACKGROUND

This invention relates generally to packaging for integrated circuits.

Generally, integrated circuit packaging may be divided into two groups. One group of packaging is suitable for radio frequency components and the other group of packaging is suitable for other non-radio frequency components such as memory or logic. Generally, radio frequency packaging involves special considerations due to the higher frequencies. Conventionally, such radio frequency packaging has shorter signal paths, but this means that there are fewer input/output possibilities.

Conversely, with conventional logic and memory packaging, longer length signal paths may be tolerated. As a result, more input/output connections are possible.

In many cases, products may have both radio frequency and non-radio frequency components.

### BRIEF DESCRIPTION OF THE DRAWINGS

FIG. 1 is a bottom plan view of one embodiment of the present invention;

FIG. 2 is an enlarged, cross-sectional view at an early stage of manufacture of the embodiment shown in FIG. 1;

FIG. 3 is an enlarged, cross-sectional view at a subsequent stage of manufacture in accordance with one embodiment of the present invention;

FIG. 4 is an enlarged, cross-sectional view at a subsequent stage of manufacture in accordance with one embodiment of the present invention;

FIG. 5 is an enlarged, cross-sectional view at still an additional stage of manufacture in accordance with one embodiment of the present invention;

FIG. 6 is an enlarged, cross-sectional view at a subsequent stage of manufacture in accordance with one embodiment of the present invention;

FIG. 7 is an enlarged, cross-sectional view at an early stage of manufacture of another embodiment of the present invention;

FIG. 8 is an enlarged, cross-sectional view at a subsequent stage of manufacture in accordance with one embodiment of the present invention;

FIG. 9 is an enlarged, cross-sectional view at a subsequent stage of manufacture in accordance with one embodiment of the present invention;

FIG. 10 is an enlarged, cross-sectional view at a subsequent stage of manufacture in accordance with one embodiment of the present invention; and

FIG. 11 is an enlarged, cross-sectional view at a subsequent stage of manufacture in accordance with one embodiment of the present invention.

### DETAILED DESCRIPTION

In accordance with some embodiments of the present invention, a single package may have the attributes of shorter signal paths, needed by radio frequency components, and more input/output connections, used by logic and memory applications. These combined characteristics may be provided in a single package that is able to handle both memory or logic, as well as radio frequency integrated circuits. Thus, a single package may have many applications in radio frequency products because many such products also need logic and memory. Providing a single package which performs multiple functions may, in some embodiments, reduce costs.

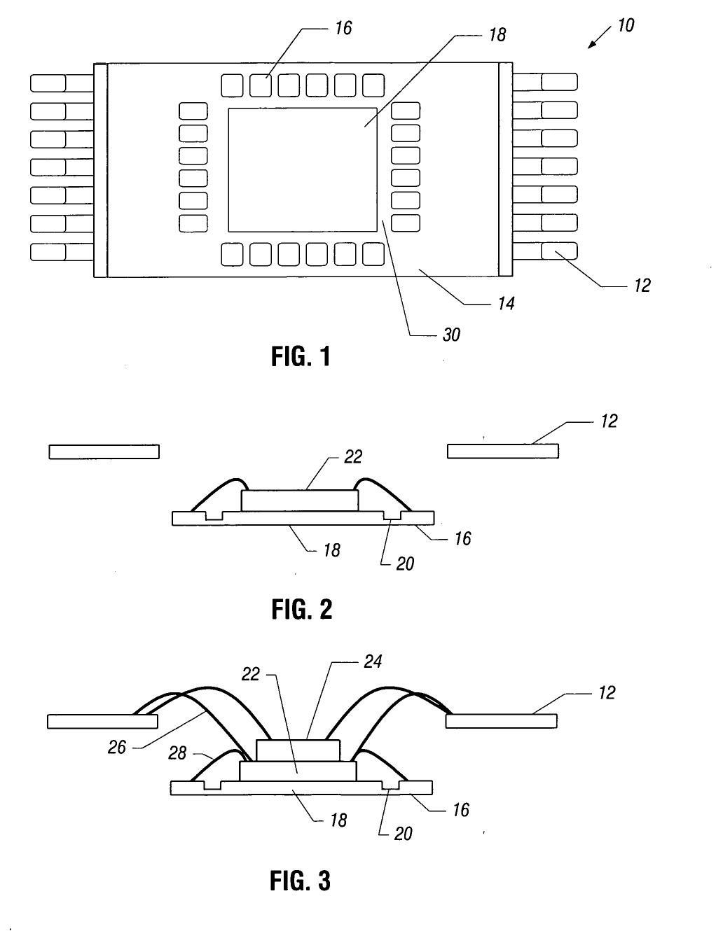

Referring to FIG. 1, the bottom of the package 10 may include an exposed die paddle 18, radio frequency pads 16, and longer leads 12. Thus, the longer leads 12 may connect to integrated circuits which are not used for radio frequency application and the shorter or no lead lands 16 may be connected to integrated components within the package that have radio frequency applications.

The exposed die paddle 18 may be effective in heat dissipation.

In accordance with some embodiments of the present invention, the fabrication of the package 10 may begin, as shown in FIG. 2, with a die paddle 18 and a radio frequency integrated circuit 22 mounted thereon. Radio frequency integrated circuit 22 may be wirebonded to the die paddle 18 as indicated. The no lead lands 16 are indicated as still connected to the die paddle 18 in the configuration shown in FIG. 2. Conventional leads 12 are provided, while the die paddle 18 and its lands 16 are wirebonded, no wirebonds have yet been applied to the leads 12.

Then, referring to FIG. 3, wirebonding may be commenced from both the lower radio frequency integrated circuit 22 to the leads 12 and from a stacked, overlying smaller dimensioned logic or memory integrated circuit die 24 to the leads 12. Thus, in some cases, components within the radio frequency integrated circuit 22 may not need the shorter leads provided by the lands 16 and may be connected externally through the conventional leads 12. This allows the radio frequency integrated circuit 22 to have more input/output connections, increasing its capability.

Because the upper integrated circuit 24, which may be used for memory or logic applications, is smaller, an area of the upper surface of the radio frequency integrated circuit 22 is available for wirebonding connections. Thus, the wire bonds 28 extend from the integrated circuit 22 to the lands 16 and the wirebonds 26 extend from the integrated circuit 22 to the leads 12.

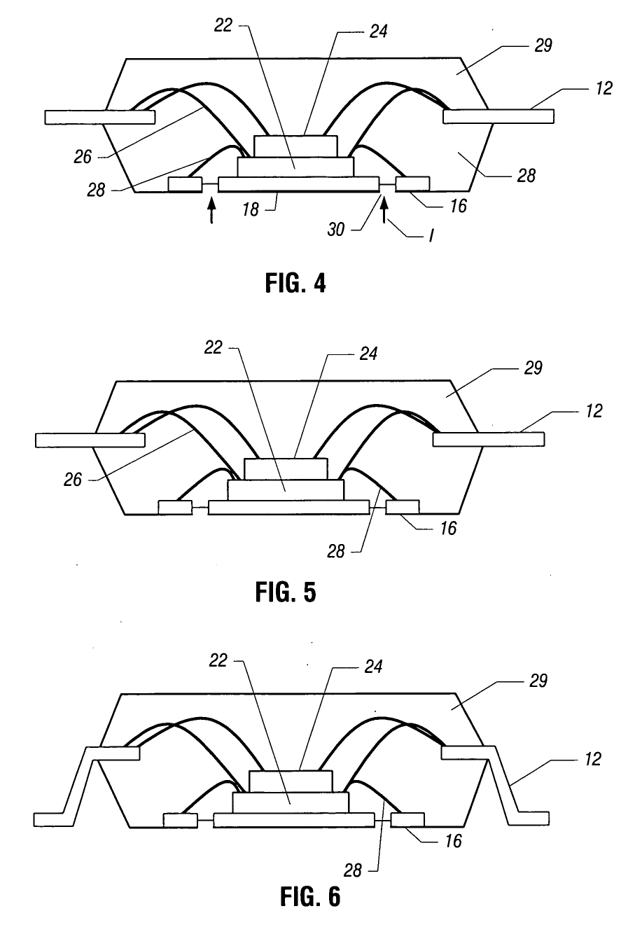

Thereafter, the stacked integrated circuits 22 and 24 may be encapsulated, as shown in FIG. 4, by a suitable encapsulant 29. The leads 12 may then be bent and singulated, as shown in FIG. 6.

Referring to FIG. 5, lands 16 may be separated from the die paddle 18 using a laser beam or an appropriately arranged cutting blade, to mention two techniques.

Thus, in some embodiments, two integrated circuit chips may be integrated into one package, saving assembly costs and providing enhanced design flexibilities by combining both radio frequency and memory or logic devices in a single solution. In addition, higher input/output counts may be achieved, compared to conventional radio frequency packages, while still providing enhanced radio frequency performance for certain integrated circuit functions that may involve higher frequencies. In some embodiments, enhanced solder joint reliability may be achieved at the board level as peripheral leads enhance the attachment to the board.

In some embodiments, the die paddle 18 may be attached to a substrate or printed circuit board by a conductive paste or solder. The lands 16 provide the most electrically efficient path since they are the shortest path from the die to the external board. The stacking configuration of integrated circuits 22 and 24 preferably provides the radio frequency device on the bottom and the flash or logic on top. The upper non-radio frequency integrated circuit may use leads as its electrical connection since lower frequency devices are less sensitive to electrical path requirements.

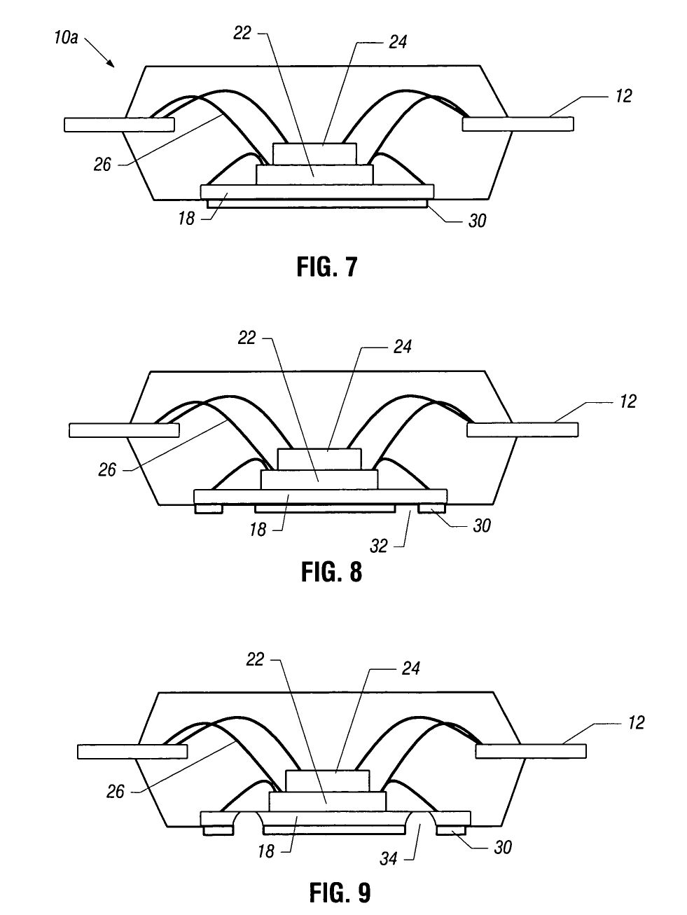

Referring to FIG. 7, in accordance with another embodiment of the present invention, an integrated die paddle 18 may be provided in the exposed position on the bottom of the package 10a. Thereafter, a photosensitive photoresist coating 30 may be applied. The coating 30 is then exposed and developed as indicated in FIG. 8.

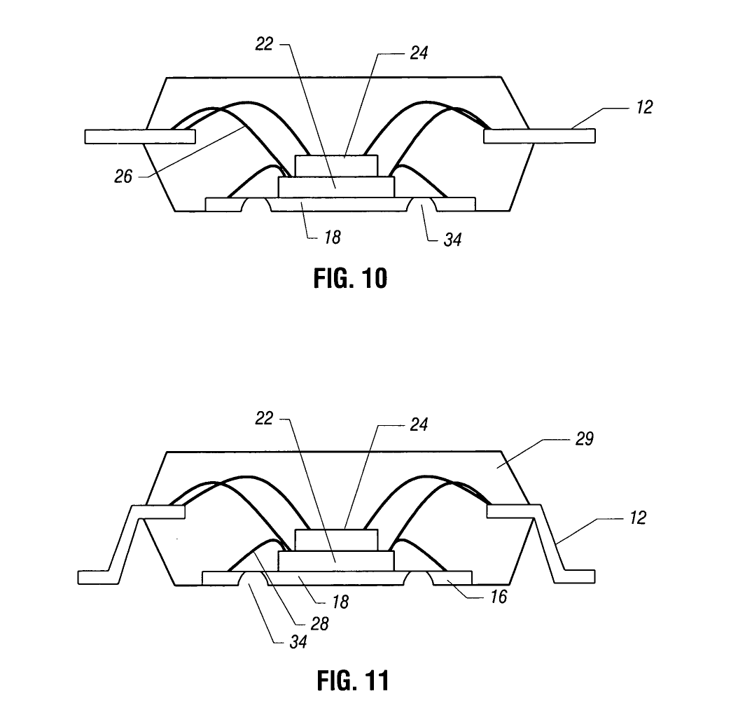

Thereafter, the exposed, patterned layer 30 with the openings 32 may be exposed to chemical etching to etch the paddle 18 as shown in FIG. 9. As a result, in one embodiment an anisotropic notch 34, formed by an anisotropic etchant, may be formed completely through the paddle 18 and the photoresist 30 may be stripped, as shown in FIG. 10. As a result, the lands 16 may be defined separately from the paddle 18. The leads 12 may be singulated and bent as shown in FIG. 11.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
providing a single integrated circuit package with a pair of dice, one die including radio frequency components and the other die including non-radio frequency components;
providing leads for the non-radio frequency component die; and
providing leadless lands for the radio frequency component die.

2. The method of claim 1 including stacking said non-radio frequency component die and said radio frequency component die on top of one another.

3. The method of claim 2 including stacking said non-radio frequency component die on top of said radio frequency component die.

4. The method of claim 3 including using a non-radio frequency component die that is smaller than said radio frequency component die.

5. The method of claim 1 including forming said package with an exposed die paddle.

6. The method of claim 1 including providing a die paddle integrated with lands and separating said lands from said die paddle.

7. The method of claim 6 including severing said lands using a cutting device.

8. The method of claim 6 including severing said lands using a laser.

9. The method of claim 6 including severing said lands using etching.

10. The method of claim 1 including coupling leads to said non-radio frequency component die.

11. The method of claim 10 including coupling leads to said radio frequency component die.

12. The method of claim 11 including coupling wirebonds to lands on said radio frequency component die.

13. An electronic device comprising:
a first radio frequency integrated circuit die;
a second non-radio frequency integrated circuit die;
a package surrounding said dice;
lands for electrical connections to the said first radio frequency die; and
leads coupled to said second non-radio frequency die.

14. The device of claim 13 including quad flat no-lead connections to said radio frequency die.

15. The device of claim 13 including thin small outline package leads for said non-radio frequency die.

16. The device of claim 13 wherein said dice are stacked.

17. The device of claim 16 wherein said non-radio frequency die is stacked on top of said radio frequency die.

18. The device of claim 17 wherein said non-radio frequency die has a smaller footprint than said radio frequency die.

19. The device of claim 13 including a die paddle exposed on the bottom of said package.

20. The device of claim 19 including lands to connect to said radio frequency die, wirebonds coupled from said lands to said radio frequency die, wirebonds connecting said non-radio frequency die to leads, and wirebonds coupled from said leads to said radio frequency die.

21. An electronic device comprising:
a first integrated circuit die;
a second integrated circuit die stacked on top of said first integrated circuit die;
quad flat no-lead connections to said first integrated circuit die; and
thin small outline package connections to said second integrated circuit die.

22. The device of claim 21 wherein said first integrated circuit die is a die with radio frequency components.

23. The device of claim 22 wherein said second integrated circuit die is a die without radio frequency components.

24. The device of claim 21 wherein said first integrated circuit die has a larger footprint than said second integrated circuit die.

25. The device of claim 21 including a package surrounding said first and second integrated circuit dice and an exposed die paddle on one side of said package.
